(19) United States
(12) Patent Application Publication
(10) Pub. No.: US 2017/0115878 A1
(43) Pub. Date: Apr. 27, 2017

(54) PROACTIVELY TUNING A STORAGE ARRAY

(71) Applicant: Pure Storage, Inc., Mountain View, CA (US)

(72) Inventor: MAYUR DEWAIKAR, DUBLIN, CA (US)

(21) Appl. No.: 14/920,935

(22) Filed: Oct. 23, 2015

(51) Int. Cl. G06F 3/06

(52) U.S. Cl. CPC G06F 3/061; G06F 3/0632; G06F 3/0653; G06F 3/0689

(57) ABSTRACT

Proactively tuning a storage array includes: determining, in dependence upon telemetry from a storage array supporting a workload having one or more particular workload attributes, whether performance settings of the storage array meet predefined criteria specified in a best practices template for the particular workload attributes; and responsive to determining that the performance settings of the storage array do not meet the predefined criteria specified in the best practices template for the particular workload attributes, applying one or more performance settings specified in the best practices template to the storage array.

### BACKGROUND

Field of Technology

The field of technology is data processing, or, more specifically, methods, apparatus, and products for proactively tuning a storage array.

Description of Related Art

Data centers may include many computing components including servers, network devices, and storage arrays. As the need for storage of large amounts of data and efficient access to that data increases, storage array technology is advancing. Such storage arrays may provide persistent storage for any number of computing devices in a data center. As the number of storage arrays in a data center increases and the types of such storage arrays begins to vary, different storage arrays may support different types of workloads. Each type of workload may operate or perform more or less efficiently in dependence upon various factors. Some factors affecting performance or operation of workloads include performance settings of the storage array that supports the workload. Any one particular user of a storage array may be unaware of optimal performance settings for a particular type of workload. As such, educated guesses are typically utilized in selecting performance settings for a storage array supporting a workload.

### SUMMARY

Methods, apparatus, and products for proactively tuning a storage array are disclosed in this specification. Proactively tuning such a storage array includes: determining, in dependence upon telemetry from a storage array supporting a workload having one or more particular workload attributes, whether performance settings of the storage array meet predefined criteria specified in a best practices template for the particular workload attributes; and responsive to determining that the performance settings of the storage array do not meet the predefined criteria specified in the best practices template for the particular workload attributes, applying one or more performance settings specified in the best practices template to the storage array.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system configured for proactively tuning a storage array according to embodiments of the present invention.

FIG. 2 sets forth a block diagram of several example computers useful for proactively tuning a storage array according to embodiments of the present invention.

FIG. 3 sets forth a block diagram of an example storage controller of a storage array.

FIG. 4 sets forth a flow chart illustrating an exemplary method for proactively tuning a storage array according to embodiments of the present invention.

FIG. 5 sets forth a flow chart illustrating another example method for proactively tuning a storage array according to embodiments of the present invention.

FIG. 6 sets forth a flow chart illustrating another example method for proactively tuning a storage array according to embodiments of the present invention.

FIG. 7 sets forth a flow chart illustrating another example method for proactively tuning a storage array according to embodiments of the present invention.

### DETAILED DESCRIPTION OF EXEMPLARY EMBODIMENTS

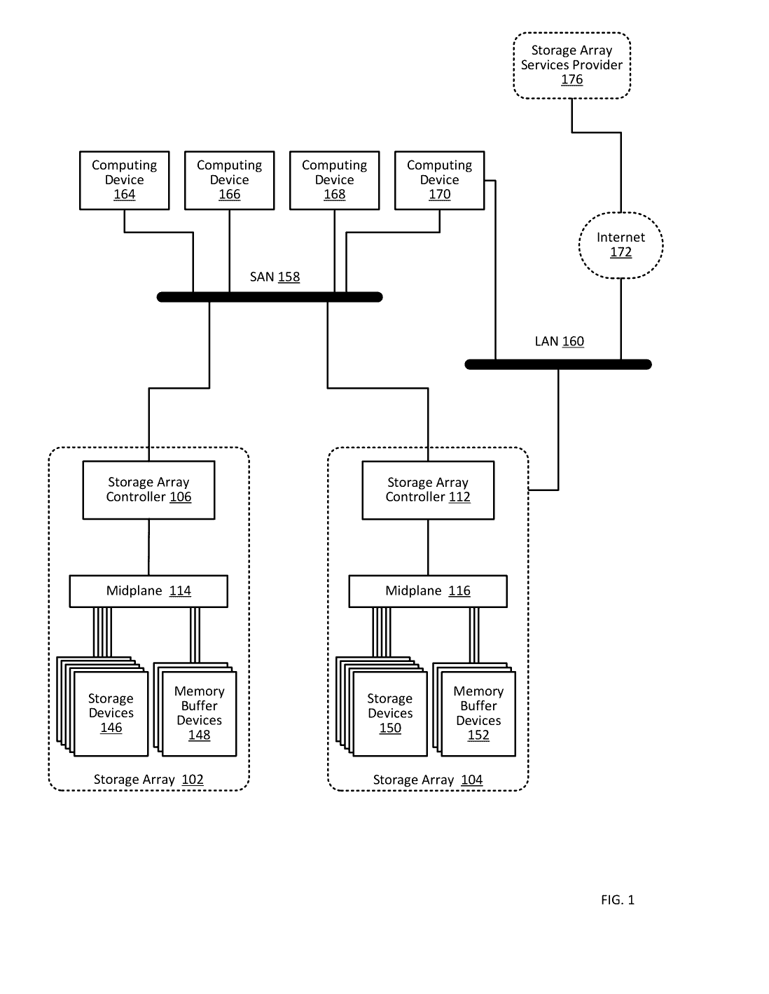

Exemplary methods, apparatus, and products for proactively tuning a storage array in accordance with the present invention are described with reference to the accompanying drawings, beginning with FIG. 1.

FIG. 1 sets forth a block diagram of a system configured for proactively tuning a storage array according to embodiments of the present invention. The system of FIG. 1 includes a number of computing devices (164, 166, 168, 170). Such computing devices may be implemented in a number of different ways. For example, a computing device may be a server in a data center, a workstation, a personal computer, a notebook, or the like.

The computing devices (164-170) in the example of FIG. 1 are coupled for data communications to a number of storage arrays (102, 104) through a storage area network (SAN) (158) as well as a local area network (160) (LAN). The SAN (158) may be implemented with a variety of data communications fabrics, devices, and protocols. Example fabrics for such a SAN may include Fibre Channel, Ethernet, Infiniband, SAS (Serial Attached Small Computer System Interface), and the like. Example data communications protocols for use in such a SAN (158) may include ATA (Advanced Technology Attachment), Fibre Channel Protocol, SCSI, iSCSI, HyperSCSI, and others. Readers of skill in the art will recognize that a SAN is just one among many possible data communications couplings which may be implemented between a computing device and a storage array. Any other such data communications coupling is well within the scope of embodiments of the present invention.

The local area network (160) of FIG. 1 may also be implemented with a variety of fabrics and protocols. Examples of such fabrics include Ethernet (802.3), wireless (802.11), and the like. Examples of such data communications protocols include TCP (Transmission Control Protocol), UDP (User Datagram Protocol), IP (Internet Protocol), HTTP (HyperText Transfer Protocol), WAP (Wireless Access Protocol), HDTP (Handheld Device Transport Protocol), SIP (Session Initiation Protocol), RTP (Real Time Protocol) and others as will occur to those of skill in the art.

The example storage arrays (102, 104) of FIG. 1 provide persistent data storage for the computing devices. Each storage array (102, 104) includes a storage controller (106, 112). The storage controller is a module of automated computing machinery comprising computer hardware, computer software, or a combination of computer hardware and software. The storage controller may be configured to carry out various storage-related tasks. Such tasks may include writing data received from a computing device to storage, erasing data from storage, retrieving data from storage to provide to a computing device, monitoring and reporting of disk utilization and performance, performing RAID (Redundant Array of Independent Drives) or RAID-like data redundancy operations, compressing data, encrypting data, and so on.

Each storage controller (106, 112) may be implemented in a variety of ways, including as an FPGA (Field Programmable Gate Array), a PLC (Programmable Logic Chip), an ASIC (Application Specific Integrated Circuit), or computing device that includes discrete components such as a central processing unit, computer memory, and various adapters. Each storage controller (106, 112) may, for example, include a data communications adapter configured to support communications via the SAN (158) and the LAN (160). Only one of the storage controllers (112) in the example of FIG. 1 is depicted as coupled to the LAN (160) for data communications for clarity. Readers should understand that both storage controllers (106, 112) are independently coupled to the LAN (160). Each storage controller (106, 112) may also, for example, include an I/O controller or the like that couples the storage controller (106, 112) for data communications, through a midplane (114), to a number of storage devices (146, 150), and a number of write buffer devices (148, 152) devices.

Each write buffer device (148, 152) may be configured to receive, from the storage controller (106, 112), data to be stored in the storage devices (146). Such data may originate from any one of the computing devices (164-170). In the example of FIG. 1, writing data to the write buffer device may be carried out more quickly than writing data to the storage device. The storage controller (106, 112) may be configured to effectively utilize the write buffer devices (148, 152) as a quickly accessible redundant buffer for data destined to be written to storage. In this way, if the storage device to which the data is to be written fails or if the write does not complete, the write buffer device may maintain the data to be written during a retry of the write or during failover of the storage device to another location. That is, the write buffer device may provide redundancy for the storage devices.

A ‘storage device’ as the term is used in this specification refers to any device configured to record data persistently. The term ‘persistently’ as used here refers to a device's ability to maintain recorded data after loss of a power source. Examples of storage devices may include mechanical, spinning hard disk drives, Solid-state drives (“Flash drives”), and the like.

In addition to being coupled to the computing devices through the SAN (158), the storage arrays may also be coupled to the computing devices through the LAN (160) and to one or more cloud service providers through the Internet (172). The term ‘cloud’ as used in this specification refers to systems and computing environments that provide services to user devices through the sharing of computing resources through a network. Generally, the user device is unaware of the exact computing resources utilized by the cloud system to provide the services. Although in many cases such ‘cloud’ environments or systems are accessible via the Internet, readers of skill in the art will recognize that any system that abstracts the use of shared resources to provide services to a user through any network may be considered a cloud-based system.

One example cloud service useful in systems such as those depicted in FIG. 1 may include a cloud-based storage array administration module. Such a cloud-based storage array administration module may be configured to proactively tune a storage array in accordance with the embodiments of the present invention. An example of such a cloud-based storage array administration module is depicted in FIG. 1 as a storage array services provider (176). The storage array service provider (176) may be configured to provide various storage array services such as reporting of storage array performance characteristics, configuration control of the storage arrays, and the like. The storage array services provider may rely on modules executing on the storage array itself to gather or process such data.

The storage array services provider (176) may proactively tune a storage array according to embodiments of the present invention by receiving telemetry from a storage array (102). The storage array (102) supports a workload characterized by a plurality of attributes. Such attributes may include IOPS (input/output operations per second), bandwidth, capacity utilization, data reduction ratio, and workload type. Examples of workload types may include virtual machines, databases, file servers, data backup services, and the like. In some embodiments, workload type may be vendor specific or version specific. Consider, for example, two storage arrays which each support a database. The databases may be different types of databases; one may be a SQL database, and the other may be an Oracle™. In some embodiments, the databases may be characterized as the same workload type, while in other embodiments the databases may be characterized as different workload types. That is, because the two databases are different database types (different vendors), the two databases may be characterized, in some embodiments, as different workload types. Consider another example in which two storage arrays each host a file system for a particular operating system, such as Microsoft Windows™. Consider also that each of the operating systems is a different version; one is a Windows 7™ operating system another is a Windows 10™ operating system. In some embodiments, the two operating systems may be characterized as different workload types due to the different operating system version.

‘Telemetry’ as the term is used in this specification refers to data provided periodically by a storage array to a cloud-service or collected by the cloud-service from the storage array. The telemetry data may describe a number of various attributes of the storage array including, for example, present capacity utilization, instantaneous bandwidth, instantaneous I/O (input/output) operations per second, instantaneous data reduction ratio, logs, metadata, and so on as will occur to readers of skill in the art.

In some examples, the telemetry may also include current performance settings. Performance settings, also referred to as ‘tuning parameters,’ are various settings which may be altered to tune the performance of the storage array. Such settings may effectively enable a user to prioritize amongst different types of performance. For example, a user may, through the setting of tuning parameters, increase the priority of I/O operation throughput relative to bandwidth utilization or data reduction ratio. In another example, a user may, through the setting of tuning parameters, set all performance parameters to an equal ratio. In some instances, performance of a particular workload type may be optimized through the alteration of various performance settings.

The storage array services provider (176) may also determine, in dependence upon the telemetry, whether performance settings of the storage array meet predefined criteria specified in a best practices template for the particular workload attributes. A ‘best practices template’ as the term is used in this specification refers to one or more data structures that specify various criteria for optimum performance settings for a workload having particular workload attributes. That is, each best practices template is a template for workloads characterized by at least one common attribute. In some embodiments, for example, a best practices template may be generated for each different workload type. The predefined criteria of the best practices template may include any types of criteria including, for example, acceptable tolerances, acceptable Boolean logic values, required settings, minimum or maximum threshold values, and so on as will occur to readers of skill in the art.

A best practices template may be generated based on data received by the storage array services provider (176) from a plurality of storage arrays that support a workload of the same attributes. Being a cloud-service, the storage array services provider (176) may be configured to receive telemetry from many storage arrays, even those owned and operated by different entities in some embodiments. In such a system, the storage array services provider may collect telemetry from many storage arrays that support a workload having at least one attribute in common. Then, automatically, or manually, that telemetry may be compared to identify performance settings that result in optimum performance for workloads having one or more common attributes.

If the performance settings of the storage array (102) do not meet the predefined criteria of the performance settings specified in the best practices template, the storage array services provider (176) may apply the performance settings specified in the best practices template. Such an application may be carried out in the background without the user's knowledge or only upon a user's approval of a change in the performance settings.

The arrangement of computing devices, storage arrays, cloud-based service providers, networks and other devices making up the exemplary system illustrated in FIG. 1 are for explanation, not for limitation. Systems useful according to various embodiments of the present invention may include different configurations of servers, routers, switches, computing devices, and network architectures, not shown in FIG. 1, as will occur to those of skill in the art. Consider, for example, that the tuning of the storage array set forth in FIG. 1 is described as being carried out by the cloud-based storage array services provider. However, the same steps may be carried out by a module of computer program instructions executing on the storage array itself.

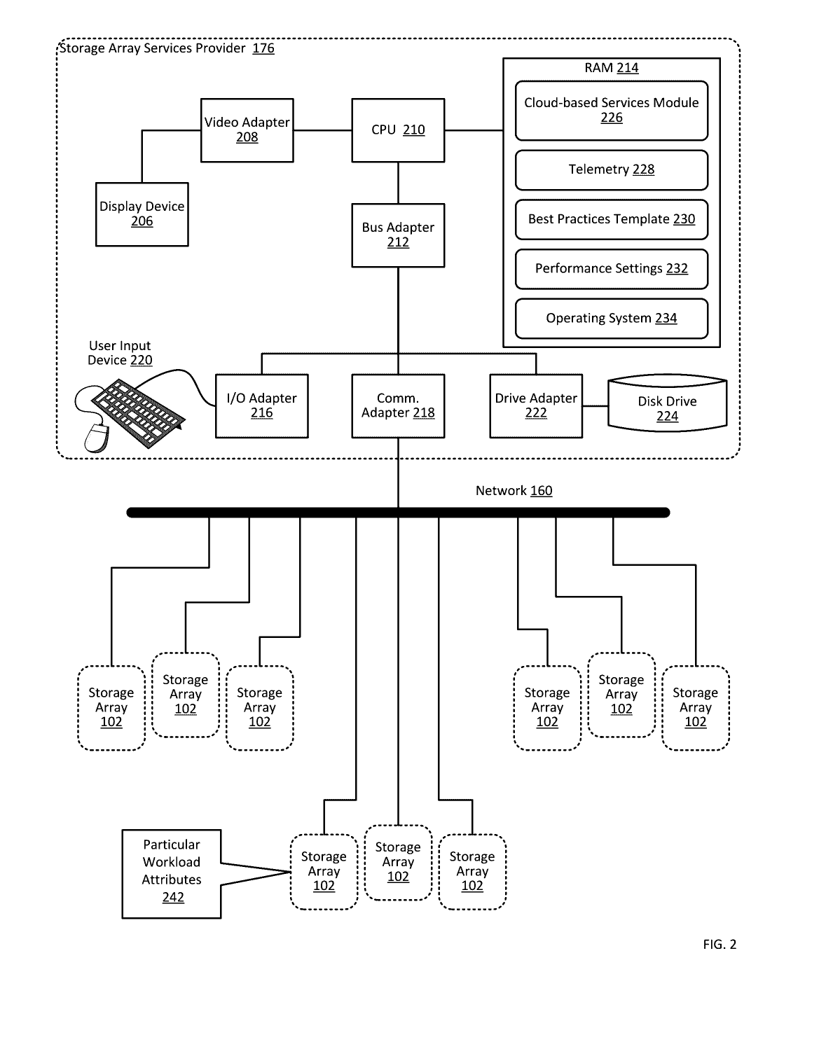

Proactively tuning a storage array in accordance with embodiments of the present invention is generally implemented with computers. In the system of FIG. 1, for example, all the computing devices (164-170), storage controllers (106, 112), storage array services provider (176), and identity provider (174) may be implemented, to some extent at least, as computers. For further explanation, therefore, FIG. 2 sets forth a block diagram of several example computers useful for proactively tuning a storage array according to embodiments of the present invention. The example computers in FIG. 2 include a storage array services provider (176).

The storage array services provider (176) of FIG. 2 includes at least one computer processor (210) or ‘CPU’ as well as random access memory (214) (RAM′) which is connected through a high speed memory bus and bus adapter (212) to processor (210) and to other components of the storage array services provider (176). Stored in RAM (214) is a cloud-based services module (226), a module of computer program instructions that when executed causes the storage array services provider (176) to proactively tune a storage array. The cloud-based services module (226) may proactively tune a storage array by receiving telemetry (228) from a storage array. In the example of FIG. 2, each of the storage arrays (102) may be configured to provide such telemetry periodically. In some instances, the storage arrays (102) may provide the telemetry often such as, for example, every 30 seconds. Each of the storage arrays in the example of FIG. 2 supports a workload. One storage array (102) supports a workload characterized by one or more particular workload attributes (242).

The cloud-based services module (226) may also determine, in dependence upon the telemetry (238), whether performance settings (232) of the storage array meet the predefined criteria specified in a best practices template (230) for the particular attributes of the workload (242). If the performance settings (232) of the storage array (102) do not meet the predefined criteria specified in the best practices template (230), the cloud-based services module (226) may apply the performance settings specified in the best practices template.

Also stored in RAM (214) of the example storage array services provider (176) is an operating system (234). Examples of operating systems useful in computers configured for proactively tuning a storage array according to embodiments of the present invention include UNIX™, Linux™, Microsoft Windows™, and others as will occur to those of skill in the art. The operating system (234) and the cloud-based storage array services module (226) in the example of FIG. 2 are shown in RAM (168), but many components of such software typically are stored in non-volatile memory also, such as, for example, on a disk drive (224). Likewise, the modules depicted in RAM (238, 240) of the storage array (102) and client-side user computer (204) may be stored in non-volatile memory.

The storage array services provider (176) of FIG. 2 also includes disk drive adapter (222) coupled through an expansion bus and bus adapter (212) to the processor (210) and other components of the storage array services provider (176). Disk drive adapter (222) connects non-volatile data storage to the storage array services provider (176) in the form of disk drive (224). Disk drive adapters may be implemented in a variety of ways including as SATA (Serial Advanced Technology Attachment) adapters, PATA (Parallel ATA) adapters, Integrated Drive Electronics (‘IDE’) adapters, Small Computer System Interface (SCSI′) adapters, and others as will occur to those of skill in the art. Non-volatile computer memory also may be implemented as an optical disk drive, electrically erasable programmable read-only memory (so-called ‘EEPROM’ or ‘Flash’ memory), RAM drives, and so on, as will occur to those of skill in the art.

The example storage array services provider (176) of FIG. 2 includes one or more input/output (‘I/O’) adapters (216). I/O adapters implement user-oriented input/output through, for example, software drivers and computer hardware for controlling output to display devices such as computer display screens, as well as user input from user input devices (220) such as keyboards and mice. The example storage array services provider (176) of FIG. 2 also includes a video adapter (208), which is an example of an I/O adapter specially designed for graphic output to a display device (206) such as a display screen or computer monitor. Video adapter (208) is connected to the processor (210) through a high speed video bus.

The exemplary storage array services provider (176) of FIG. 2 includes a communications adapter (218) for data communications with the storage arrays (102) through the network (160). Such data communications may be carried out through data communications networks such as IP data communications networks, and in other ways as will occur to those of skill in the art. Communications adapters implement the hardware level of data communications through which one computer sends data communications to another computer, directly or through a data communications network. Examples of such communications adapters useful include modems for wired dial-up communications, Ethernet (IEEE 802.3) adapters for wired data communications, and 802.11 adapters for wireless data communications.

Readers of skill in the art will recognize that the components of the storage array services provider (176) as depicted in FIG. 2 are example computing components only. Such a storage array services provider (176) may be configured in various ways including, for example, as a server. Such a server may not include the I/O adapters, the driver adapters, display devices, video adapters and the like.

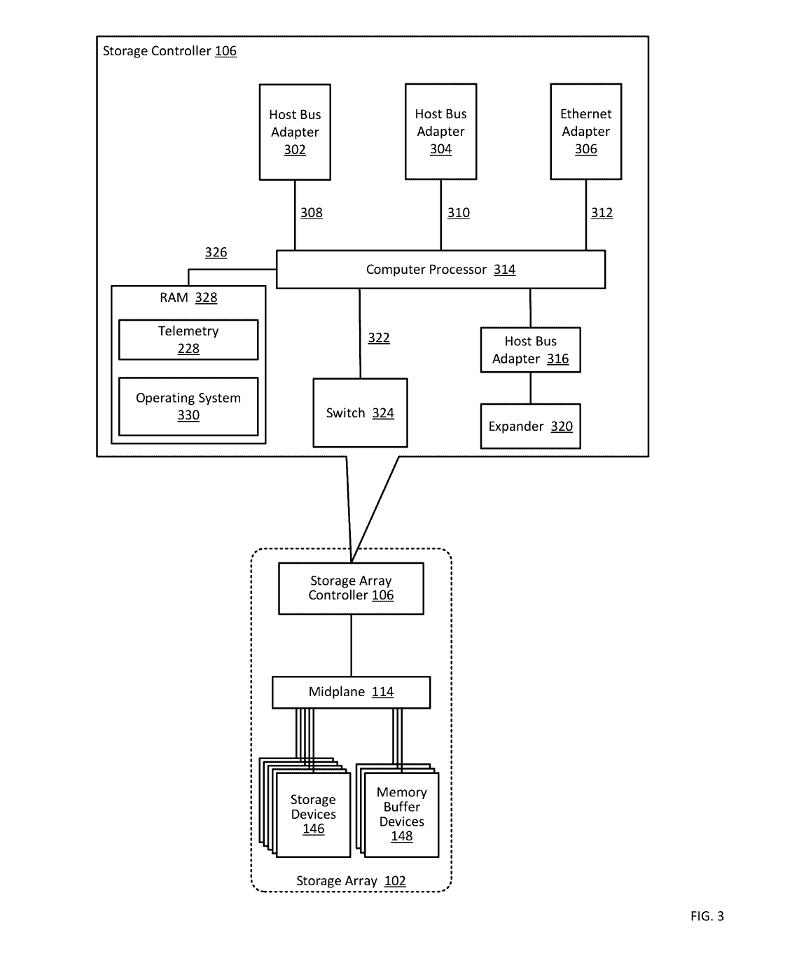

As mentioned above, a storage array (102) may also be implemented, at least to some extent, as a computer. For further explanation, therefore, FIG. 3 sets forth a block diagram of an example storage controller (106) of a storage array (102). The example storage controller includes a computer processor (314). The computer processor is coupled to RAM (214) through a DDR4 (Double-Data Rate 4) bus. Stored in RAM (214) is an operating system (330) and telemetry (230). Such telemetry may include performance metrics from various components of the storage array as well as one or more performance settings of the storage array (102).

The processor (314) is also coupled for data communications through PCIe (Peripheral Component Interface express) links (308, 310, 312, 322) to several Fibre Channel host bus adapters (302, 304), an Ethernet adapter (306), and a PCIe switch (324). The Fibre Channel host bus adapters (308, 310) may couple the storage controller to a storage area network, such the SAN (158) depicted in the example of FIGS. 1 and 2. The Ethernet adapter (306) may couple the storage controller to a local area network such as the LAN (160) depicted in the example of FIGS. 1 and 2. The PCIe switch (324) may provide data communications across other PCI links through the midplane to PCI endpoints, such as storage devices or write buffer devices. Likewise, the processor (314) is also coupled through a SAS (Serial Attached SCSI) host bus adapter (316) to a SAS expander (320). The SAS expander may provide SAS connections between the computer processor (314) and other devices through the midplane.

Readers of skill in the art will recognize that these components, protocols, adapters, and architectures are for illustration only, not limitation. Such a storage controller may be implemented in a variety of different ways. Each such way is well within the scope of the present invention.

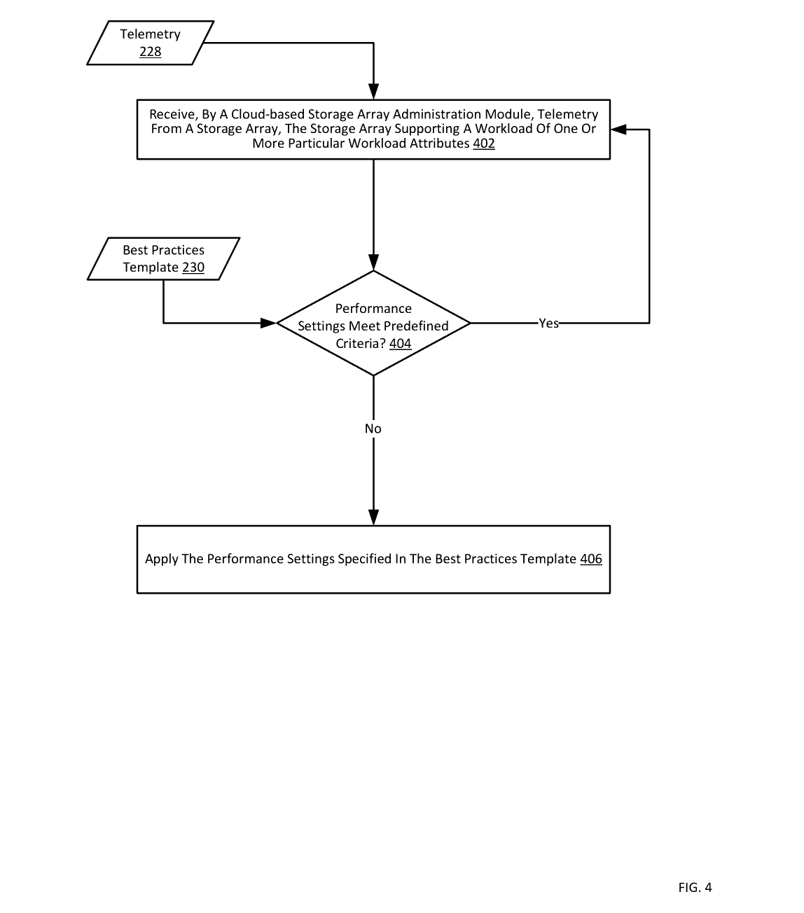

For further explanation, FIG. 4 sets forth a flow chart illustrating an exemplary method for proactively tuning a storage array according to embodiments of the present invention. The method of FIG. 4 may be carried out by a cloud-based storage array administration module such as the cloud-based storage array services provider (176 in the example of FIG. 1).

The method of FIG. 4 includes receiving (402) telemetry (228) from a storage array, where the storage array supports a workload characterized by one or more particular workload attributes. Receiving (402) telemetry (228) from a storage array may be carried out by periodically or on-demand receiving data from a storage array through one or more data communications networks and an Application Programming Interface (‘API’) exposed to the storage array designated for the purpose of receiving such data.

The method of FIG. 4 also includes determining (404), in dependence upon the telemetry, whether performance settings of the storage array meet the predefined criteria specified in a best practices template (230) for the particular workload attributes. Determining (404) whether the performance settings of the storage array meet the predefined criteria may be carried out by comparing the present performance settings of the storage array to the criteria specified for such settings in the best practices template. The performance settings of the storage array may be received from the storage array as part of the telemetry or be otherwise reported by the storage array or otherwise retrieved from the storage array. Such a comparison may be dependent on the type of criteria specified in the best practices template. For example, in some embodiments, the criteria may include a tolerance of acceptable values for a performance setting. In some embodiments, the criteria may include minimum or maximum threshold values for performance settings. In some embodiments, the criteria may specify a Boolean logic value (true or false) for a particular performance setting. A best practices template may include any of these types of criteria in any combination as well as others not mentioned here.

If the performance settings of the storage array do not meet the predefined criteria specified in the best practices template (230), the method of FIG. 4 continues by applying (406) the performance settings specified in the best practices template. Applying (406) the performance settings may be carried out in various ways including, for example, by transmitting, over a data communications network and via an API call, the performance settings without the user's knowledge or providing an option to change the settings to a user. In the latter case, applying (406) the performance settings may be carried out only upon a user's approval to make such a change.

If the performance settings of the storage array do meet the predefined criteria specified in the best practices template (230), no change to the performance settings is made and the cloud-based administration module carrying out the method of FIG. 4 repeats the cycle of receiving telemetry and determining whether performance settings meet the predefined criteria. In some embodiments, the attributes of the workload supported by the storage array may change over time and the performance settings may change over time. To that end, determining (404) whether performance settings of the storage array meet the predefined criteria of performance settings specified in a best practices template may be carried out periodically.

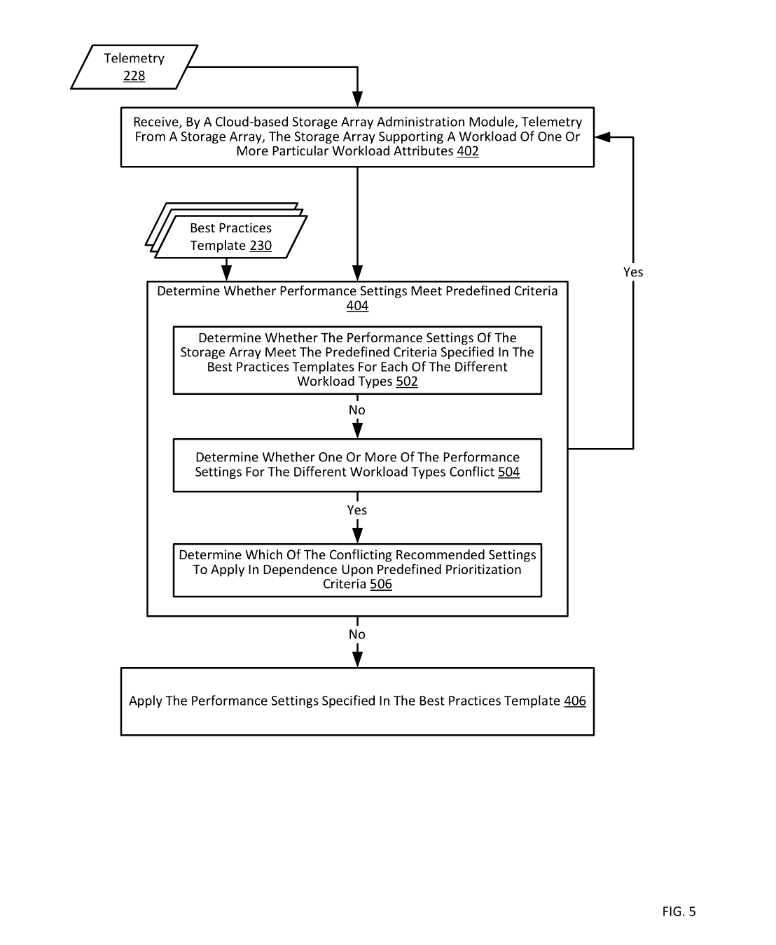

For further explanation, FIG. 5 sets forth a flow chart illustrating another example method for proactively tuning a storage array according to embodiments of the present invention. The method of FIG. 5 is similar to the method of FIG. 4 in that the method of FIG. 5 may also be carried out by a cloud-based storage array administration module such as the cloud-based storage array services provider (176 in the example of FIG. 1). The method of FIG. 5 is also similar to the method of FIG. 4 in that the method of FIG. 5 includes receiving (402) telemetry (228) from a storage array; determining (404) whether performance settings of the storage array meet the predefined criteria of performance settings specified in a best practices template (230); and if the performance settings of the storage array do not meet the predefined criteria, applying (406) the performance settings specified in the best practices template.

The method of FIG. 5 differs from the method of FIG. 4, however, in that the storage array supports workloads of different workload types. To that end, in the method of FIG. 5, determining (404) whether performance settings of the storage array meet the predefined criteria of performance settings specified in the best practices template also includes determining (502) whether the performance settings of the storage array meet the predefined criteria of the performance settings for the best practices templates for each of the different workload types.

If the performance settings of the storage array do not meet the predefined criteria, the method of FIG. 5 continues by determining (504) whether one or more of the performance settings for the different workload types conflict. Consider, for example, that a best practices template for a first workload type specifies a high data reduction ratio performance setting, while a best practices template for a second, different workload type specifies a low data reduction ratio performance setting. In such an embodiment, a storage array supporting workloads of both the first and second type may have best practice performance settings that conflict.

If one or more of the performance settings for the different workload types conflict, the method of FIG. 5 continues by determining (506) which of the conflicting recommended settings to apply in dependence upon predefined prioritization criteria. Predefined prioritization criteria is any criteria that specifies a priority of applying performance settings from best practices template to a storage array. In some embodiments, the criteria may be predefined by a user of a storage array. A user may, for example, specify that one workload type is a higher priority than another workload type or specify that one or more performance settings have a higher priority than other performance settings. In such a manner, the performance setting of the conflicting settings that meets the predefined prioritization is applied (406).

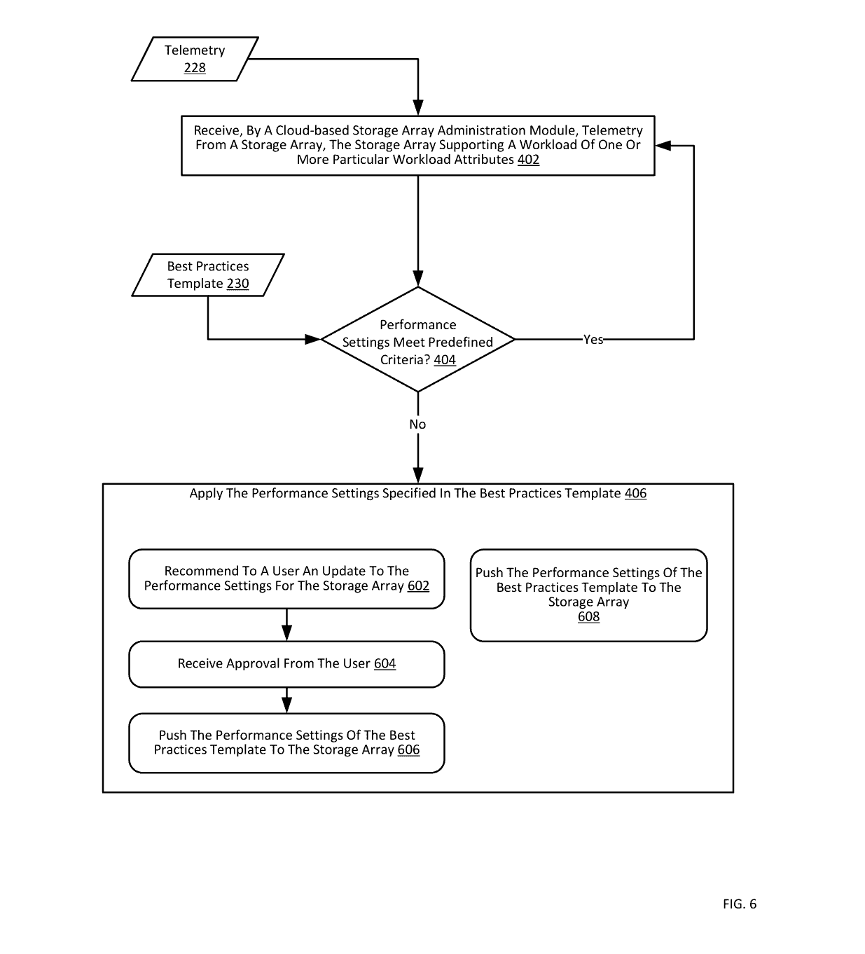

For further explanation, FIG. 6 sets forth a flow chart illustrating another example method for proactively tuning a storage array according to embodiments of the present invention. The method of FIG. 6 is similar to the method of FIG. 4 in that the method of FIG. 6 may also be carried out by a cloud-based storage array administration module such as the cloud-based storage array services provider (176 in the example of FIG. 1). The method of FIG. 6 is also similar to the method of FIG. 4 in that the method of FIG. 6 includes receiving (402) telemetry (228) from a storage array; determining (404) whether performance settings of the storage array meet the predefined criteria of performance settings specified in a best practices template (230); and if the performance settings of the storage array do not meet the predefined criteria, applying (406) the performance settings specified in the best practices template.

The method of FIG. 6 differs from the method of FIG. 4, however, in that the method of FIG. 6 includes several options for applying (406) the performance settings specified in the best practices template. In some embodiments, applying (406) the performance settings specified in the best practices template may be carried out by: recommending (602) to a user an update to the performance settings for the storage array; receiving (604) approval from the user to apply the performance settings and, upon receiving the approval from the user, pushing (606) the performance settings of the best practices template to the storage array.

In some embodiments, applying (406) the performance settings specified in the best practices template may be carried out by pushing (608) the performance settings of the best practices template to the storage array. Such pushing (608) may be carried out entirely without the user's knowledge or approval.

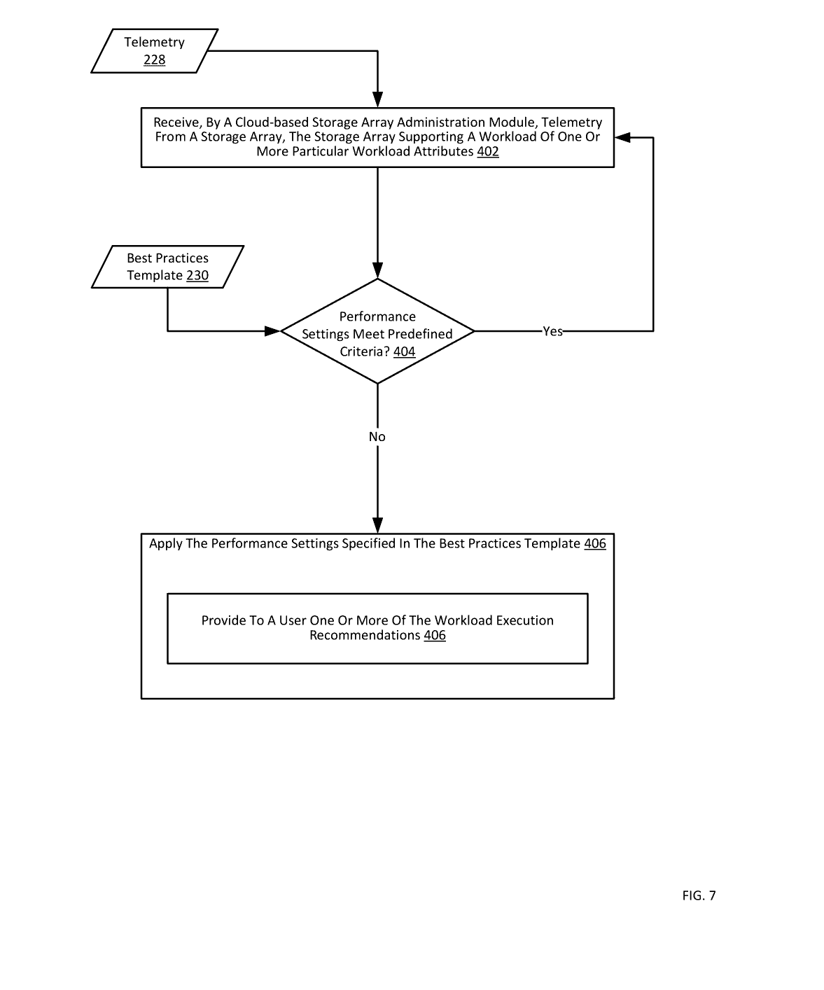

For further explanation, FIG. 7 sets forth a flow chart illustrating another example method for proactively tuning a storage array according to embodiments of the present invention. The method of FIG. 7 is similar to the method of FIG. 4 in that the method of FIG. 7 may also be carried out by a cloud-based storage array administration module such as the cloud-based storage array services provider (176 in the example of FIG. 1). The method of FIG. 7 is also similar to the method of FIG. 4 in that the method of FIG. 7 includes receiving (402) telemetry (228) from a storage array; determining (404) whether performance settings of the storage array meet the predefined criteria specified in a best practices template (230); and if the performance settings of the storage array do not meet the predefined criteria, applying (406) the performance settings specified in the best practices template.

The method of FIG. 7 differs from the method of FIG. 4, however, in that the best practices template also includes one or more workload execution recommendations. Workload execution recommendations may include any change to an execution parameter of a workload that cannot be initiated directly by the cloud-based storage array administration module or carried out without a user's intervention. For example, some virtual machine environments supported by a storage array may perform optimally only when the number of virtual machines or size of the virtual machines is below a predefined threshold. The cloud-based storage array administration module, however, may not be configured to modify the execution parameters of the workload itself, but may only be enabled to configure performance settings of the storage array.

To that end, applying (406) the performance settings specified in the best practices template in the method of FIG. 7 includes providing (406) to a user one or more of the workload execution recommendations. That is, the cloud-based storage array administration module may identify workload execution parameters that are out of line with the recommended workload execution parameters specified in the best practices template and provide the recommendations to the user. The user, with such knowledge, may adjust the execution of the workload itself to increase performance.

Exemplary embodiments of the present invention are described largely in the context of a fully functional computer system. Readers of skill in the art will recognize, however, that the present invention also may be embodied in a computer program product disposed upon computer readable media for use with any suitable data processing system. Such computer readable storage media may be any transitory or non-transitory media. Examples of such media include storage media for machine-readable information, including magnetic media, optical media, or other suitable media. Examples of such media also include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware, as hardware, or as an aggregation of hardware and software are well within the scope of embodiments of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of proactively tuning a storage array, the method comprising:
determining, in dependence upon telemetry from a storage array supporting a workload having one or more particular workload attributes, whether performance settings of the storage array meet predefined criteria specified in a best practices template for the particular workload attributes; and
responsive to determining that the performance settings of the storage array do not meet the predefined criteria specified in the best practices template for the particular workload attributes, applying one or more performance settings specified in the best practices template to the storage array.

2. The method of claim 1, wherein:
the storage array supports workloads of different workload types; and
determining whether performance settings of the storage array meet the predefined criteria specified in the best practices template for the particular workload attributes further comprises determining whether the performance settings of the storage array are meet predefined criteria specified in the best practices template for each of the different workload types.

3. The method of claim 2, further comprising:
responsive to determining that the performance settings of the storage array do not meet the predefine criteria specified in the best practices template for each of the different workload types, determining whether one or more performance settings specified in the best practices templates for the different workload types conflict; and
responsive to determining that one or more of the performance settings specified in the best practices template for the different workload types conflict, determining which of the conflicting performance settings to apply in dependence upon predefined prioritization criteria.

4. The method of claim 1, wherein applying the performance settings specified in the best practices template further comprises:
recommending to a user an update to the performance settings for the storage array;
upon receiving approval from the user, pushing the performance settings of the best practices template to the storage array.

5. The method of claim 1, wherein applying the performance settings specified in the best practices template further comprises:
pushing the performance settings of the best practices template to the storage array.

6. The method of claim 1, wherein:
the best practices template for the particular workload attributes further comprises one or more workload execution recommendations; and
applying the performance settings specified in the best practices template further comprises providing to a user one or more of the workload execution recommendations.

7. The method of claim 1, wherein:
determining whether performance settings of the storage array meet predefined criteria specified in the best practices template for the particular workload attributes is carried out periodically.

8. An apparatus for proactively tuning a storage array, the apparatus comprising a computer processor, a computer memory operatively coupled to the computer processor, the computer memory having disposed within it computer program instructions that, when executed by the computer processor, cause the apparatus to carry out the steps of:
determining, in dependence upon telemetry from a storage array supporting a workload having one or more particular workload attributes, whether performance settings of the storage array meet predefined criteria specified in a best practices template for the particular workload attributes; and
responsive to determining that the performance settings of the storage array do not meet the predefined criteria specified in the best practices template for the particular workload attributes, applying one or more performance settings specified in the best practices template to the storage array.

9. The apparatus of claim 8, wherein:
the storage array supports workloads of different workload types; and
determining whether performance settings of the storage array meet the predefined criteria specified in the best practices template for the particular workload attributes further comprises determining whether the performance settings of the storage array are meet predefined criteria specified in the best practices template for each of the different workload types.

10. The apparatus of claim 9, further comprising computer program instructions that, when executed, cause the apparatus to carry out the steps of:
responsive to determining that the performance settings of the storage array do not meet the predefine criteria specified in the best practices template for each of the different workload types, determining whether one or more performance settings specified in the best practices templates for the different workload types conflict; and
responsive to determining that one or more of the performance settings specified in the best practices template for the different workload types conflict, determining which of the conflicting performance settings to apply in dependence upon predefined prioritization criteria.

11. The apparatus of claim 8, wherein applying the performance settings specified in the best practices template further comprises:
recommending to a user an update to the performance settings for the storage array;
upon receiving approval from the user, pushing the performance settings of the best practices template to the storage array.

12. The apparatus of claim 8, wherein applying the performance settings specified in the best practices template further comprises:
pushing the performance settings of the best practices template to the storage array.

13. The apparatus of claim 8, wherein:
the best practices template for the particular workload attributes further comprises one or more workload execution recommendations; and
applying the performance settings specified in the best practices template further comprises providing to a user one or more of the workload execution recommendations.

14. The apparatus of claim 8, wherein:
determining whether performance settings of the storage array meet predefined criteria specified in the best practices template for the particular workload attributes is carried out periodically.

15. A computer program product for proactively tuning a storage array, the computer program product disposed upon a computer readable medium, the computer program product comprising computer program instructions that, when executed, cause a computer to carry out the steps of:
determining, in dependence upon telemetry from a storage array supporting a workload having one or more particular workload attributes, whether performance settings of the storage array meet predefined criteria specified in a best practices template for the particular workload attributes; and
responsive to determining that the performance settings of the storage array do not meet the predefined criteria specified in the best practices template for the particular workload attributes, applying one or more performance settings specified in the best practices template to the storage array.

16. The computer program product of claim 15, wherein:
the storage array supports workloads of different workload types; and
determining whether performance settings of the storage array meet the predefined criteria specified in the best practices template for the particular workload attributes further comprises determining whether the performance settings of the storage array are meet predefined criteria specified in the best practices template for each of the different workload types.

17. The computer program product of claim 16, further comprising computer program instructions that, when executed, cause the computer to carry out the steps of:
responsive to determining that the performance settings of the storage array do not meet the predefine criteria specified in the best practices template for each of the different workload types, determining whether one or more performance settings specified in the best practices templates for the different workload types conflict; and
responsive to determining that one or more of the performance settings specified in the best practices template for the different workload types conflict, determining which of the conflicting performance settings to apply in dependence upon predefined prioritization criteria.

18. The computer program product of claim 15, wherein applying the performance settings specified in the best practices template further comprises:
recommending to a user an update to the performance settings for the storage array;
upon receiving approval from the user, pushing the performance settings of the best practices template to the storage array.

19. The computer program product of claim 15, wherein applying the performance settings specified in the best practices template further comprises:
pushing the performance settings of the best practices template to the storage array.

20. The computer program product of claim 15, wherein:
the best practices template for the particular workload attributes further comprises one or more workload execution recommendations; and
applying the performance settings specified in the best practices template further comprises providing to a user one or more of the workload execution recommendations.
